(19) United States
(12) Patent Application Publication
(10) Pub. No.: US 2014/0154349 A1
(43) Pub. Date: Jun. 5, 2014

(54) APPARATUS FOR THERMOFORMING POLYMER COMPOSITE PANELS

(71) Applicant: RUTGERS, THE STATE UNIVERSITY OF NEW JERSEY, New Brunswick, NJ (US)

(72) Inventors: Thomas Nosker, Stockton, NJ (US); Jennifer Lynch, Franklin Park, NJ (US)

(73) Assignee: RUTGERS, THE STATE UNIVERSITY OF NEW JERSEY, New Brunswick, NJ (US)

(21) Appl. No.: 13/803,744

(22) Filed: Mar. 14, 2013

Related U.S. Application Data
(60) Provisional application No. 61/733,076, filed on Dec. 4, 2012.

(51) Int. Cl. B29C 35/00

(52) U.S. Cl. CPC B29C 35/007
USPC 425/143

(57) ABSTRACT

A system and apparatus for making a plastic panel, combining:
an extruder with a heated barrel having an inlet opening, a discharge outlet and at least one screw flight therebetween;
a plurality of molding tools having top and bottom surfaces and sidewalls extending therebetween defining a cavity;
a machine press with opposing top and bottom platens configured to receive a molding tool therebetween and apply compressive force to said top and bottom surfaces; and
at least one heated vessel for receiving and storing a quantity of mixed melt, wherein the vessel has an inlet port to receive the mixed melt discharged from the barrel outlet of the extruder; a discharge port configured to deliver the mixed melt from the vessel to the cavity of the molding tool; and a metering device set to deliver the selected quantity of the mixed melt from the vessel through the discharge port.

### CROSS REFERENCE TO RELATED APPLICATIONS

The present application claims priority under 35 U.S.C. 119(e) to U.S. Provisional Patent Application Ser. No. 61/733,076, filed on Dec. 4, 2012, the contents of which are hereby incorporated by reference in its entirety.

### FIELD OF THE INVENTION

The present invention relates to an apparatus for constructing fiber glass-enhanced polymer composite materials prepared from recycled plastics and use of the apparatus in the construction of these materials.

### BACKGROUND OF THE INVENTION

Plastics are ubiquitous and play important roles in industries as well as in people's daily life. Recycled plastic materials provide an inexpensive source of plastics. Proper recycling of plastic wastes and re-processing them into useful materials or articles can not only protect environments but may also create huge economic values. However, recycled plastics are often difficult to reformulate into useable products, especially products with consistent mechanical properties.

Recycled plastics are typically obtained by curbside collection, which itself presents problems as to quality and consistency. The types of plastic materials that are typically designated for curbside recycling are unpigmented high density polyethylene (HDPE) and polyethylene terephthalate (PET), which together constitute about 80% of the collected recycled plastics. Fortunately, some industries have standardized their plastic package materials. For example, plastic milk bottles are made from unpigmented HDPE, while plastic carbonated beverage bottles are made from PET (one-piece containers) or PET/HDPE (two-piece containers). These containers are easily identified and thus are relatively easy to segregate, thereby facilitating the recycling of these two plastics. This is the reason why these two types of plastic are designated for acceptable curbside recycling designated for resin recovery.

In particular, it has been demonstrated that recycled plastics, in particular polyolefins, such as HDPE, could be recycled and reprocessed to form useful materials with high economic value, see e.g., Nosker et al, U.S. Pat. Nos. 5,298,214; 5,789,477; 6,191,228; and 7,011,253, which are all incorporated herein by reference. However, new apparatus and methods in processing recycled plastics and turning them into useful materials with wider applications are still being actively pursued.

Plastic polymers and plastic composite materials offer a viable alternative to wood and concrete. Manufactured plastic composites can exhibit the necessary stiffness strength, resistance to heat expansion and deformation, increased resistance to degradation from moisture and excessive sunlight, and attacks by microorganisms and insects. Plastic panels would also have a longer expected service life thereby reducing the labor and material costs associated with replacement.

However, the cost of raw materials is a disadvantage of plastic polymers and plastic composites. Virgin polymer resins can be quite expensive, thereby often making their use economically unfeasible. Additionally, current extrusion/compression molding apparatuses do not adequately accommodate the extrusion of recycled plastics from a wide range of sources with melt indexes that vary widely.

### SUMMARY OF THE INVENTION

The present invention provides a new apparatus for processing recycled plastics and converting them to useful materials for consumer and industrial use by processing them into panels and other useful articles by means of extrusion and compression molding.

According to one aspect of the present invention, a system and apparatus is provided for making a plastic panel, wherein the apparatus combines:

an extruder with a heated barrel, wherein the heated barrel has a feed end opening, a discharge outlet and at least one screw flight therebetween, wherein the screw flight is configured to form a uniform homogenous mixed melt of an optional glass bead or fiber reinforcing component and a polymer component at the operating temperature of the extruder from a polymer mixture delivered thereto through the barrel inlet opening;

a plurality of molding tools with top and bottom surfaces and sidewalls extending therebetween defining a cavity dimensioned to produce the plastic panel of predetermined thickness;

a heated machine press with opposing top and bottom platens configured to receive one of the molding tools therebetween and apply compressive force to the top and bottom surfaces to form the plastic panel in the molding tool; and

at least one heated vessel for receiving and storing a quantity of mixed melt selected to form the plastic panel of predetermined thickness, wherein the vessel has an inlet port to receive the mixed melt discharged from the barrel outlet of the extruder; a discharge port configured to deliver the mixed melt from the vessel to the cavity of the molding tool; and a metering device set to deliver the selected quantity of mixed melt from the vessel through the discharge port to the molding tool cavity.

According to an embodiment the apparatus further includes at least one temperature controller set to maintain the extruder barrel, the heated vessel and the machine press at a temperature above the melt flow temperature of said mixed melt. According to another embodiment, the extruder is a single screw compounding extruder. According to yet another embodiment, the extruder is a twin screw extruder and, more particularly, a twin screw compounding extruder.

According to one embodiment, the metering device is a pneumatic piston. In another embodiment, the apparatus further includes at least one opening in a sidewall of the forming die to release any excess of mixed melt delivered to the die.

### BRIEF DESCRIPTION OF THE DRAWINGS

FIG. 1 is a side view of a molding tool according to the present invention with a slug of molten plastic deposited therein;

FIG. 2A illustrates the uni-axial orientation of an extruded fiber-reinforced plastic sheet;

FIG. 2B illustrates the mulit-axial orientation of an extruded fiber-reinforced plastic sheet according to the present invention; and

FIG. 3 is a diagrammatic view of a system and apparatus according to the present invention.

### DETAILED DESCRIPTION OF THE INVENTION

The present invention relates to an apparatus for manufacturing plastic articles from recycled plastics, typically polyolefins, and optional reinforcing glass beads or fibers, typically glass fibers. In particular, the present invention relates to an apparatus for processing the recycled plastics and optional reinforcing fibers into rectangular panels and other useful articles having wide application. The manufacturing apparatus embodies an extrusion-compression molding process.

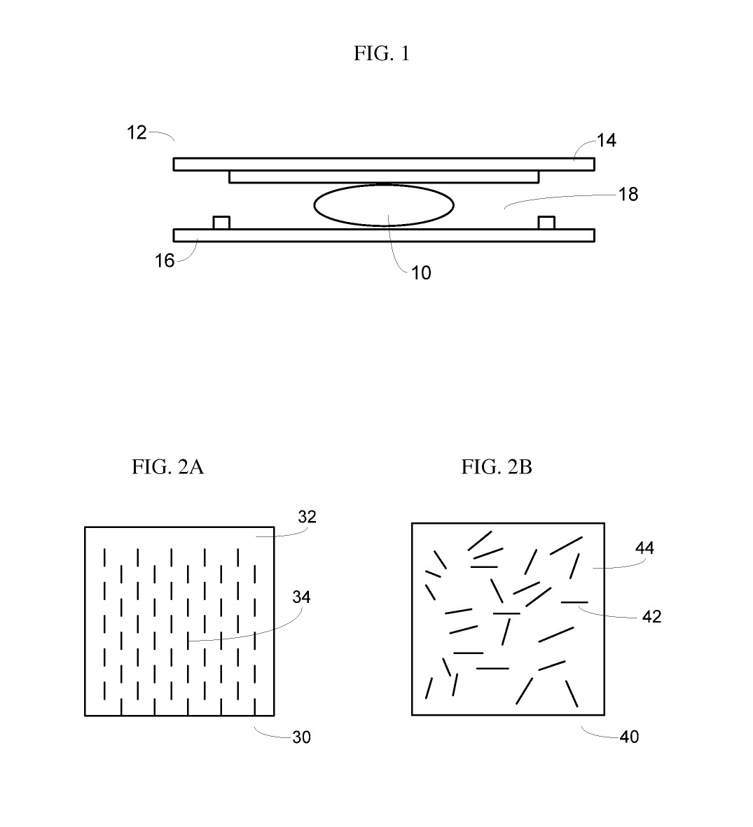

As shown in FIG. 1, in extrusion-compression molding, a molten slug of plastic 10 is deposited into an open molding tool 12, which is closed inside a press (not shown), prior to moving into ambient air cooling. Individual molding tools are used to produce the composite panels, typically 8′×4′ sheets, in thicknesses of 4 mm, 8 mm, 12 mm, etc., which allows a flexible mix of thicknesses to be produced, by reordering the mold tools. In one embodiment, “flat panel” means a piece of material, having considerable extent of surface; usually a rectangular piece of greater length than breadth and distinguished by its thinness; being more than 4 inches (102 mm) in width and not more than 2.5 inches (64 mm) in thickness.

The sheet product is used in a variety of situations, and in many different sectors. This includes, but is not limited to, construction site hoardings, signage, concrete shuttering, rain cladding, cubicle partitions, pipe boxing, sound barriers (acoustic barriers etc.), and potential replacement for internal skin of walls, ceilings & flooring. The objective is to replace timber-based products such as plywood, Medium Density Fiberboard (MDF) and compact grade laminated in a variety of situations.

The extrusion/compression moulding combination is much more tolerant of variations of the Melt Flow Index of recycled plastics. (The Melt Flow Index is a standard industry measure of the amount a given plastic material flows at a standard test temperature). Unlike a virgin grade of plastic, which is manufactured to a tight specification, recycled plastics are aggregated together when collected, and a wider spread of melt flow index is likely.

That is, a conventional sheet extrusion plant produces a constant web of molten plastic from an extruder, that is passed through a series of polished rollers and kept under constant tension while it cools and is cropped to size. This process is intolerant of changes within the melt flow index of the material. As shown in FIG. 2A, the linear sheet extrusion process, also imparts a uni-axial orientation of the plastic 32 and reinforcement 34 within the sheet 30, giving it different stiffness across the width vs. the length, and the risk of uneven shrinkage through heat reversion while in service.

The extrusion/compression molding process disclosed here is much more tolerant of variations of the Melt Flow Index. This enables the efficient of use recycled plastics from a wider range of sources, without interrupting production, and the introduction of high percentages of glass fiber reinforcement within the product that would be trouble-some to produce using sheet extrusion methods. As shown in FIG. 2B, the orientation of reinforcing glass fibers 42 within an extrusion/compression molded sheet 40 is much more varied than that of the extruded sheet. This is desirable and imparts similar properties in both width and length.

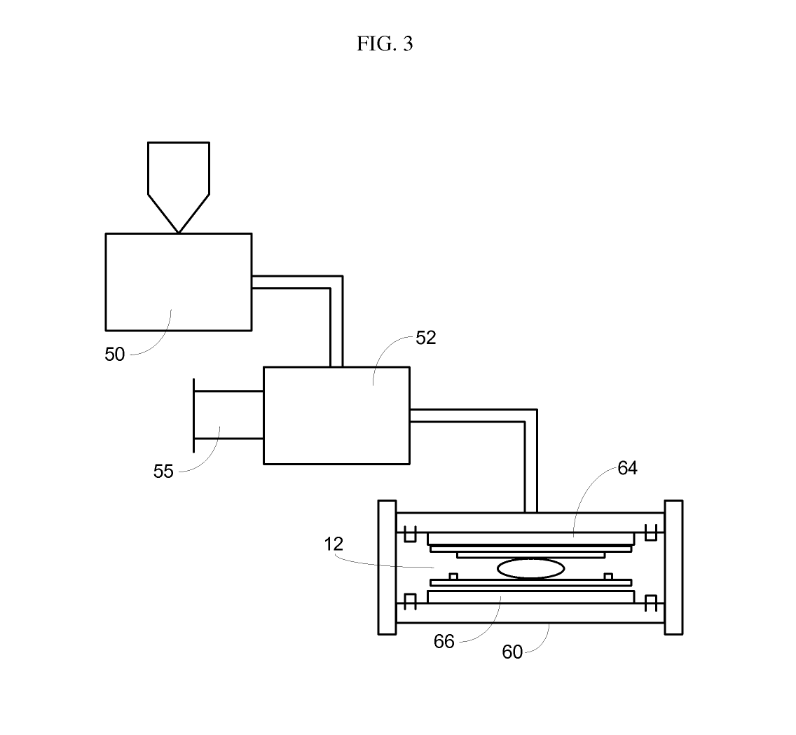

As shown in FIG. 3, a system and apparatus according to the present invention includes an extruder 50 that runs continuously at a modest output, feeding into accumulator device 52 that can empty hot plastic quickly from outlet port 54 to a cavity 18 in mold tool 12. The mold tool 12 is then inserted between platens 64 and 66 of press 60, which is a hot platen press that can take molten materials and press them into a sheet. According to one embodiment, the tooling is a vented rectangular aluminum mold tool 12 with top 14 and lower half 16. The mold tool can also have a chrome or any other metal finish (not shown) that will aid mold release.

In order to achieve an even dispersion of fibers and other components within the molten plastic, the design of the extruder 50 and screw is significant. In addition to creating an even melt of the plastic material, the extruder must disperse and distribute the additives and glass fibres evenly throughout the mix.

While essentially any compounding extruder can be adapted for use with the present invention, a long single screw compounding extruder is preferred. A screw of varying pitch and diameter is more preferred to create conditions of shear, heat and pressure within the extruder. This extruder configuration allows excellent mixing, using simple reliable equipment, primarily through dispersive mixing through high shear mixing stages within the extruder. According to one embodiment, a vented extruder is used to allow volatiles, such as steam, to be removed from the plastic melt, even though it is unlikely that wet material will be fed into the extruder.

In one embodiment, a 120/130 mm diameter extruder is used with a mixing screw modified to reduce output from nominal specification to around 400 kg/hr. In another embodiment, a water chiller is installed to provide a temperature regulated supply of cooling water for the extruder barrel. Larger diameter extruder barrels require water cooling.

Preferred single screw compounding extruders include a Model Taskmaster 1000 single screw compounding extruders manufactured by Randcastle Extrusion Systems, Inc. of Cedar Grove, N.J., disclosed in U.S. Provisional Application No. 61/477,826, filed on Apr. 21, 2011, which is hereby incorporated by reference. This application discloses a method of just in time compounding in which extruder-compounded compositions are directly fed to molding equipment.

In an alternative embodiment, the extruder is a twin screw extruder and, more particularly, a twin screw compounding extruder.

Post extrusion, the hot molten plastic mix is it transferred via discharge outlet 51 to the accumulator device 52. This is a cylindrical steel vessel 56, heated by electrical heater bands 58 and 59, where the molten material is stored until it is required, when it is discharged through a port 54 using a pneumatically operated piston 55 into cavity 18 of mold tool 12. In one embodiment, two accumulators are fitted to the production machine (not shown)—this arrangement allows the extruder to run continuously and at a more efficient steady state.

In an alternative embodiment, a die head (not shown) is provided on the extruder outlet for forming the hot molten plastic mix into pellets or flakes. The pellets or flakes are solidified and packaged by conventional means well known in the art of plastic formulation.

To create a material blend as close to a standard set of properties as possible, polymer materials from two to four sources are obtained, preferably non-virgin. The incoming polymer materials are preferably aggregated together to average out any inconsistencies as much as possible. Materials are blended together in batches of up to two tons.

The other key incoming raw material is glass fiber strands or glass beads, which, when used, are compounded into the plastic in the extruder. In one embodiment, a combination of industrial waste fiber and virgin fiber is used. According to one embodiment, silane is used to pre-coat the glass fiber. In another embodiment, a coupling agent such as maleic anhydride in combination with a free radical initiator such a cumene peroxide, is used to graft the silane coated fibers to polyolefins to provide a composite material with a desirable combination of stiffness and toughness, attributable to the bond achieved between the fibres and the polyolefin.

The viscosity of the molten plastic increases significantly with increasing glass fiber content and fiber length. Accordingly, the outlet port 54 of the accumulator 52, shown in FIG. 3, should be dimensioned sufficiently to minimize the time necessary to deliver the molten plastic into the mold.

Fibers over 13 mm in length are prone to bridging in the feed inlet of the extruder. Accordingly, apparatuses according to the present invention may optionally include a small feeder screw or stuffing hopper (not shown) to deliver longer fiber material accurately into the extruder 50.

A system and apparatus according to the present invention may also optionally include a hot air dryer (not shown). While none of the materials used are significantly hygroscopic, it is possible that recycled and washed incoming material has residual moisture which should be removed prior to extrusion.

A system and apparatus according to the present invention may also optionally include a gravimetric blender 70 installed above the feed end inlet 51 of the extruder 50. This device creates a small batch of accurately proportioned material in a chamber over the extruder feed, where it is discharged into a vertical tube 49. The rate of discharge of material into the extruder 50 through the feed end inlet 51 can be adjusted to meet the desired feed rate of the extruder.

In one embodiment, a small screw feeder (not shown) is positioned immediately above the throat 49 at the feed inlet 51 of the extruder 50 to dispense a small percentage of carbon black powder into the material mix. This is a dusty material, so it is preferably positioned here to minimize plant cleaning. Other plastic molding additives can be delivered here as well.

Each accumulator will be configured to store and discharge the correct amount of material for either a 4 mm or 8 mm rectangular sheet. A 12 mm thick sheet will require two accumulators to discharge into the same mold cavity.

A programmable logic controller (not show) is used to control sequencing of dies and accumulator discharge. The programming is capable of being performed by one of ordinary skill in the relevant art.

The mold tools traverse around a conveyor line (not shown) controlled by the logic controller, which allows a variable and flexible product mix by varying the number of 4 mm, 8 mm and 12 mm tools on the line at a time. Each of the tools can be marked for identification by the control system by conventional means.

An infra-red heating station (not shown) is positioned on the conveyor line in advance of the accumulator to pre-heat the mold tools in advance of the molten material discharge. The logic controller will then control the output and duration of the infra-red pre-heater and synchronize the movement of the mold tools into and out of preheating. An infra-red heating system is used because rapid yet controllable increases in temperature are possible because of the high radiant heating efficiency of the heater and the high thermal conductivity of the aluminium mold tooling. The mold tool 12 is preferably preheated to an adequate temperature before the molten plastic is applied to allow the plastic material to flow over the entire surface of the tool without sticking to the surface of the tool or changing phase. Typically, this is a temperature between about 100 and about 125° C.

A mold release/lubricant may be applied to the aluminium surface of the tool to be contacted by the molten plastic. For example, a heavy application of mineral oil may be applied to both tool faces.

After the mold tool 12 has been preheated, the top half 14 of the tool will pass by the delivery point of the accumulator and move directly to a tool mating station (not shown), where it will be lifted and rotated to await the arrival of the lower half 16 of the tool 12. The preheated lower half 16 of the tool 12 will move under the outlet 54 of the accumulator in synchronous movement with the accumulator piston 55—allowing a metered amount of material to be fed into position within the mold tool.

In one embodiment, the extruder 50 and accumulator 52 are mounted at right angles to mold tool 12 on a movable trolley (not shown). The trolley is pushed parallel to the mold tool during accumulator discharge to ensure an even application of molten material 10 into the cavity 18 of the lower half 16 of the mold tool 12. An effective pattern of material distribution from the accumulator into the tool cavity is a dog bone shape, which allows a slight overfilling of the mold. This pattern, combined with corner vents 15 on the lower half 16 of the mold tool 12 consistently produce panels of acceptable quality.

The lower half 16 of each mold tool 12 is then mated with the top half 14, and moved into a heated press 60 where the molten plastic 10 is squeezed between the top and lower tools halves until the tool is fully closed. Platen presses suitable for use with the present invention have a closing force of at least 90 tons, and preferably at least 150 tons. A closing force of 90 tons is able to consistently compression mold production samples, although more time is needed for the sausage shaped slug of hot plastic to flow and reach the vent ports 15 of the mold tool 12. Additional force and preheating of tooling prior to delivery of molten plastic into the tool and closure will reduce cycle time considerably,

After a short time under pressure in the press 60, the mold tool 12 is moved to a cooling conveyor (not shown), where it is cooled using ambient air, fans and water spray (not shown). In one embodiment, this is an accumulating gravity conveyor, so the mold tools will safely wait until the unloading operator is ready.

Preferably, the vent ports 15 are cleared of molten plastic before the molded sheet cools below 90° C. If this is not carried out the excess material within the vent ports cools more quickly than the material inside the mould cavity and restricts shrinkage on internal mould areas nearby. This uneven shrinkage exhibits itself as a “stretched” area of the finished sheet which then bows out of plane of the rest of the sheet.

After the mold tool 12 and product within is cooled until the product is rigid enough to be safely removed from the mold tool, the mold tool is opened by an operator using a small overhead crane unit. The product is lifted out and placed on a table where the operator inspects the product and removes any excess flash with a heated knife.

In another embodiment quality approved products are placed on input conveyor (not shown) of corona discharge machine (not shown). Plastics from the olefin family have traditionally had many virtues, including relatively low cost, but have a low energy surface in their unmodified state, making use of coatings and adhesives difficult. However, flame or corona treatment of the surface can change the characteristics of the plastics surface, creating a higher energy surface, to which coatings, adhesives, paints, foils, and laminating can bond successfully. For example, a corona treatment process and/or Electron Beam Curing process (not shown) is optionally installed at the end of the process line to treat all output sheets. The compact grade alternative product is used for, but not limited to, laboratory furniture, lockers, external building cladding and washroom cubicles.

A gradual rate of cooling is beneficial in establishing a flat molding when moldings are thicker than 2 mm. It is important to keep compressive stresses induced by shrinkage on cooling even throughout the molding. In thicker moldings, such as the 8 mm thick products, it is not beneficial to cool the outer skin of the molding at a rate greater than the rate at which heat is rejected from the inner core of the molding to the outer surface. Furthermore, the presence of a significant amount of glass fiber within the molding reduces greatly the in-mould shrinkage of the moulding. Observations of 25% glass fiber reinforced products indicate shrinkages of 0.3% across the width of the 8 mm sheets and 1% along the length. This difference in shrinkage is believed to be related to the general orientation of the fibres—more fibres are aligned across the width of the sheet than along the length.

In addition to the polyolefin and fiber glass components, the composite may contain further additives. For example, the material used to make the composite can contain small amounts of a blowing agent to reduce the number and size of voids formed within the material during cooling, the amount of which can be, for example, less than 0.3 wt. %, e.g., about 0.03 wt. %. The blowing agent, e.g., azidocarbonamide, can be mixed in with the resin powder. Alternatively, other foaming agents or gases can be directly metered into the extruder. Conventional compounding additives can also be combined with the polymer(s) prior to extrusion. Suitable additives for the composite panels include pigments, UV resistant agents, colorants (such as carbon black), modifiers, fillers, particles, compatibilizers, and the like. In one embodiment that includes glass fibers, they are any length suitable for extrusion. In another embodiment, the plastic is selected from high density polyethylene (HDPE) and blends of polypropylene (PP) with HDPE; and polystyrene (PS) with HDPE. In one embodiment, the plastic is virgin material.

An exemplary effective blend, in regard of the above described desired properties, used silane to precoat the glass fibre, along with the FUSABOND™ additive. This combination provides a consistent combination of stiffness and toughness due to the strongest bond being achieved between the fibres and the HDPE plastic.

### Example

### Materials

Two components were used for the experimental mixing study, including fiber-glass (FG) and recycled plastics. The FG is typical micron-sized E Glass (d=20 microns, L=4 mm). Recycled plastics include those containing high-density polyethylene (HDPE) as the main component, for example, milk bottles, car bumpers, etc.

### Manufacturing

Product was manufactured according to the following stages. Recycled HDPE Granulate was blown into fabric silos. Recycled HDPE from several sources was then mixed to average out inconsistencies in supplied material. Material was blended with additional glass fiber, carbon black and additives. A long single screw extruder (L/d 36:1 circa 120 mm diameter 350 kg output) was used to compound the material blend. A screw of varying pitch and diameter was used to create conditions of shear, heat and pressure within the extruder. A vented extruder was used to allow volatiles, such as steam, to be removed from the plastic melt. A water chiller unit was provided to supply temperature regulated cooling water to the extruder barrel.

Post extrusion, the hot molten plastic/glass fiber mix was stored within an accumulator device. This accumulator is a steel cylinder, heated by electrical heater bands, where the molten material was stored until sufficient quantity accumulated to fill a mold tool cavity, when it was then discharged through a port using a pneumatically operated piston.

The mold tools traversed around a conveyor line. The control system pre-set the output and duration of the Infra Red pre-heater and synchronize the movement of the tool into preheating.

After the tool was preheated, the top half of the tool passed by the delivery point of the accumulator and was moved directly to the tool mating station where it was lifted and rotated prior to arrival of the lower half of the tool. The preheated lower half of the tool moved under the outlet of the accumulator in synchronous movement with the accumulator piston, allowing a metered amount of material to be fed into position within the tool.

The lower half of each tool was then mated with the top half and moved into a heated press where the molten plastic was squeezed between the top and lower tools halves until the tool is fully closed. After a short time under pressure in the press, the tool was moved to a cooling conveyor where it was cooled using ambient air, fans and water spray. After the tool and product within was cooled until it was rigid enough to be safely removed from the tool the tool was opened by an operator using a small overhead crane unit. The product was lifted out and placed on a table where the operator inspected the product and removed excess flash with a heated knife.

Quality approved products were then placed on the input conveyor of the Corona Discharge machine.

It will be understood by those of skill in the art that numerous and various modifications can be made without departing from the spirit of the present invention. Therefore, it should be clearly understood that the various embodiments of the present invention described herein are illustrative only and not intended to limit the scope of the present invention. All references cited herein are incorporated by reference in their entirety. Citation of any patent or non-patent references does not constitute admission of prior art.

1. A system and apparatus for making a plastic panel, the apparatus comprising:
an extruder comprising a heated barrel, said heated barrel comprising a feed end inlet, a discharge outlet and at least one screw flight therebetween, wherein said screw flight is configured to form a uniform homogenous mixed melt of an optional glass bead or fiber reinforcing component and a polymer component at the operating temperature of said extruder from a polymer and fiber mixture component delivered thereto through said barrel inlet opening;
a plurality of molding tools comprising top and bottom surfaces and sidewalls extending therebetween defining a cavity dimensioned to produce said plastic panel at a predetermined thickness;
a heated machine press with opposing top and bottom platens configured to receive one of said molding tools therebetween and apply compressive force to said top and bottom surfaces; and
at least one heated vessel for receiving and storing a quantity of said mixed melt selected to form a plastic panel of said predetermined thickness, said vessel comprising an inlet port to receive said mixed melt discharged from said barrel outlet of said extruder; a discharge port configured to deliver said mixed melt from said vessel to the cavity of said molding tool; and a metering device set to deliver said selected quantity of said mixed melt from said vessel through said discharge port to said molding tool cavity.

2. The system and apparatus of claim 1, further comprising at least one temperature controller set to maintain said extruder barrel, said heated vessel and said machine press at a temperature above the melt flow temperature of said mixed melt.

2. The system and apparatus of claim 1, wherein said extruder is a single screw compounding extruder.

3. The system and apparatus of claim 1, wherein said extruder is a twin screw extruder.

4. The system and apparatus of claim 1, further comprising at least one vent in a sidewall of said forming die to release any excess of said mixed melt delivered to said die.

5. The system and apparatus of claim 1, further comprising a thermoforming press for thermoforming said plastic composite panel into a finished article.

6. The system and apparatus of claim 5, wherein said thermoforming press is configured to produce a finished article selected from the group consisting of a corrugated panel, an embossed panel, a boat hull, an aircraft hull, an automotive component and a reaction vessel.

7. The system and apparatus of claim 1, wherein a surface of at least one of said molding tool surfaces or a surface of a press platen in contact with said molding tool is configured to emboss a pattern or an image on said panel.

8. The system and apparatus of claim 1, further comprising means for cooling said plastic panel in said molding tool after said forming die is removed from said machine press.
